(19) United States
(12) Patent Application Publication
(10) Pub. No.: US 2022/0195275 A1
(43) Pub. Date: Jun. 23, 2022

(54) Biocompatible Oil Herders and Methods of Use

(71) Applicants: Zhengdong Cheng, College Station, TX (US); Roshan Sebastian, Bryan, TX (US); Lecheng Zhang, College Station, TX (US); Dali Huang, College Station, TX (US); Minxiang Zeng, College Station, TX (US); Abhijeet Shinde, College Station, TX (US); Qingsheng Wang, College Station, TX (US)

(72) Inventors: Zhengdong Cheng, College Station, TX (US); Roshan Sebastian, Bryan, TX (US); Lecheng Zhang, College Station, TX (US); Dali Huang, College Station, TX (US); Minxiang Zeng, College Station, TX (US); Abhijeet Shinde, College Station, TX (US); Qingsheng Wang, College Station, TX (US)

(73) Assignee: Texas A&M University, College Station, TX (US)

(21) Appl. No.: 17/687,405

(22) Filed: Mar. 4, 2022

Related U.S. Application Data
(63) Continuation of application No. PCT/US2020/049599, filed on Sep. 5, 2020.
(60) Provisional application No. 62/896,690, filed on Sep. 6, 2019.

(51) Int. Cl. C09K 3/32; C08B 37/00; C02F 1/68; E02B 15/08

(52) U.S. Cl. CPC C09K 3/32; C08B 37/009; C02F 2101/32; E02B 15/08; C02F 1/682

(57) ABSTRACT

Provided herein are oil herding agents, for example, a biocompatible non-ionic functionalized polysaccharide konjac glucomannan radiation-induced degraded konjac glucomannan. Also provided is a method for containing the spread of an oil spill on a water surface at a low water temperature utilizing the oil herding agent. In addition there is provided a method for preparing an oil herder, a radiation-induced degraded konjac glucomannan prepared by the method and a method for increasing a slick thickness ratio of an oil slick on a water surface utilizing the prepared oil herder.

### CROSS-REFERENCE TO RELATED APPLICATION

This is a continuation application under 35 U.S.C § 120 of pending international application PCT/US2020/049599, filed Sep. 5, 2020, which claims benefit of priority under 35 U.S.C. § 119(e) of provisional application U.S. Ser. No. 62/896,690, filed Sep. 6, 2019, the entirety of both of which is hereby incorporated by reference.

### BACKGROUND OF THE INVENTION

### Field of the Invention

The present invention relates to biocompatible agents and methods for treating mixtures of water and oil with particular utility in the field of oil spill response. Specifically, the invention relates to herding agents and herding methods utilized to mitigate the impact of a spill and facilitate oil recovery.

### Description of the Related Art

Oil spills that result from damaged oil rigs, ruptured pipelines, and tankers can have immediate and long-term detrimental effects on aquatic life and the environment. This has been evident in incidents such as the Deepwater Horizon oil spill, in which 4.9 million barrels of oil were discharged into the Gulf of Mexico.

Traditional oil herders have a number of significant shortcomings. These include the toxicity of the herding agents and lack of biocompatibility with water, which can result in the toxic herding surfactant remaining on the water's surface for long periods of time. Furthermore, these traditional herders tend to lose significant herding efficiency when used in the Arctic region as a result of their ineffectiveness at low temperatures. This is due to their relatively high Krafft Temperatures, which are the temperatures below which no micelles are formed.

Thus, there is a recognized need in the art to develop an effective oil spill recovery technique with a potential for wide-spread use in industrial applications. Specifically, the prior art is deficient in oil herder that is biocompatible, non-toxic, and highly efficient over a wide range of water temperatures, especially at low temperature areas. The present invention fulfills this longstanding need and desire in the art.

### SUMMARY OF THE INVENTION

The present invention is directed to an oil herding agent comprising a biocompatible non-ionic functionalized polysaccharide. The present invention is directed to a related oil herding agent that further comprises a non-toxic vehicle.

The present invention also is directed to a method for containing spread of an oil spill on a water surface at a low water temperature. The method comprises applying the oil herding agent described herein along a perimeter of the oil spill on the water surface.

The present invention is directed further to a method for preparing an oil herder. In the method a biocompatible non-ionic polysaccharide is irradiated with electron beam radiation to form a biocompatible non-ionic functionalized polysaccharide, thereby preparing the oil herding agent.

The present invention is directed further still to a radiation-induced degraded konjac glucomannan oil herder comprising octadecyl isocyanate and 1,3-propane sultone produced by the method described herein. The present invention is directed to a related radiation-induced degraded konjac glucomannan oil herder that further comprises a non-toxic vehicle.

The present invention is directed further still to a method for increasing a slick thickness ratio of an oil spill on a water surface. In the method the radiation-induced degraded konjac glucomannan oil herder described herein is applied along a perimeter of the oil slick on the water surface.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIGS. 1A-1B are a FTIR spectra and a molecular weight vs e-beam radiation graph to chemically characterize Konjac glucomannan. FIG. 3A is the FTIR spectra of pristine Konjac glucomannan and modified Konjac glucomannan. FIG. 3B shows the molecular weight change of modified Konjac glucomannan under various e-beam radiation dosages.

FIGS. 2A-2D are comparisons of the mechanism of ionic and non-ionic herding surfactant efficiencies. FIG. 2A is an ionic surfactant sodium dodecyl sulfate graph showing conductivity of sodium dodecyl sulfate solution in water versus temperature. FIG. 2B is a schematic illustration of the relationship of ionic surfactant conductivity versus temperature and the resulting molecular alignment. FIG. 2C is a non-ionic surfactant konjac glucomannan graph showing conductivity of modified konjac glucomannan in water versus temperature.

FIG. 2D is a schematic illustration of the relationship of non-ionic surfactant conductivity versus temperature and resulting molecular alignment.

FIGS. 3A-3B show the surface area of the oil layer and the retracted oil layer. In FIG. 3A the area of the oil layer is 101.50 cm² and thickness of the spread oil layer is 0/039 mm. In FIG. 3B Area of the oil layer is 19.65 cm² and thickness of the herded oil layer is 0.2 mm FIGS. 4A-4B illustrate the modified konjac glucomannan and the degraded modified konjac glucomannan surfactant forming monolayers on the water surface. FIG. 4A compares the arrangement of modified konjac glucomannan and the degraded modified konjac glucomannan macromolecules along the air-water interface. FIG. 4B compares the coil-in tendency.

FIGS. 5A-5D show oil herding with modified konjac glucomannan surfactant. FIG. 5A are photographs of the herding process with the modified konjac glucomannan herder dispersed in water. FIG. 5B compares herding oil slick area versus time with the modified konjac glucomannan herder dispersed in water. FIG. 5C are photographs of the herding process through the modified konjac glucomannan herder dispersed in toluene. FIG. 5D compares herding oil slick area versus time with the modified Konjac glucomannan herder dispersed in toluene.

FIGS. 6A-6D illustrate oil herding with degraded modified Konjac glucomannan irradiated with various radiation dosage in low temperature water (1° C. water). The toluene ratio 0.005 (wt/vol) and 0.4 ml of mixture is applied on the 0.4 ml dodecane (oil layer) 1° C. water. FIG. 6A is a1.21 kGy radiation dosage. FIG. 6B is a 16 kGy radiation dosage. FIG. 6C is a graph of time versus radiation. FIG. 6D is a graph of herding oil slick area versus time with modified konjac glucomannan herder dispersed in toluene. The radiation dosage is −0.561*Time+14.97.

FIGS. 7A-7C are profiles of liquid droplets to measure the surface tension. FIG. 7A is pure deionized water. FIG. 7B is hydrophobically modified konjac glucomannan solution.

FIG. 7C is a degraded and hydrophobically modified Konjac glucomannan solution. The surface tension for pure DI water, pure konjac glucomannan solution and degraded and hydrophobically modified konjac glucomannan are 79.06 mN/m, 77.50 mN/m and 77.18 mN/m. It is demonstrated that the hydrophobically modified konjac glucomannans does not have an extreme influence on the interfacial tension.

FIGS. 8A-8D compare oil slick thickness ratio changes with the herder surfactant concentration at room temperature of PEG-monolaurate (FIG. 8A), PEG-monooleate (FIG. 8B), PEG-dibenzoate (FIG. 8C), and PEG-distearate (FIG. 8D).

FIGS. 9A-9C compare oil-slick thickness ratio changes with the herder surfactant concentration. FIG. 9A compares the herder PEG-monolaurate and the herder Span-20 at 25° C. FIG. 9B compares the herder PEG-monolaurate at 4° C. water and 25° C. water. FIG. 9C compares the herder PEG-monolaurate in 3.5% saline water and pure deionized water.

FIGS. 10A-10B are photographs of pure konjac glucomannan and modified Konjac glucomannan emulsions. In FIG. 10A 4 ml of pure konjac glucomannan in water 0.0025 (wt/vol)/4 ml Dodecane forms a gel-like mixture. FIG. 10B shows the emulsion formed by 4 ml of modified konjac glucomannan in water 0.0025 (wt/vol)/4 ml Dodecane.

FIGS. 11A-11B are optical microscopic images. FIG. 11A shows that the pure konjac glucomannan forms a gel-like mixture. FIG. 13B shows the emulsion formed by modified Konjac glucomannan.

FIGS. 12A-12C illustrate the modified oil dispersant properties of Konjac glucomannan. FIG. 12A shows the floating oil layer and the bulk water phase. FIG. 12B shows the floating crude oil layer and the gelating of oil-water and KGM. FIG. 12C shows oil droplets dispersed from the floating layer and settled at the bottom emulsified by MKGM.

FIGS. 13A-13B are conductivity versus temperature graphs for 0.1 mol/L of PEG monooleate in water solution. FIG. 13A shows the temperature increased from 2.7° C. to 30° C. FIG. 13B shows the temperature decreased from 30° C. to 5° C.

### DETAILED DESCRIPTION OF THE PRESENT INVENTION

For convenience, before further description of the present invention, certain terms employed in the specification, examples and appended claims are collected herein. These definitions should be read in light of the remainder of the disclosure and understood as by a person of skill in the art. Unless defined otherwise, all technical and scientific terms used herein have the same meaning as commonly understood by a person of ordinary skill in the art.

The articles “a” and “an” when used in conjunction with the term “comprising” in the claims and/or the specification, may refer to “one”, but it is also consistent with the meaning of “one or more”, “at least one”, and “one or more than one”. Some embodiments of the invention may consist of or consist essentially of one or more elements, components, method steps, and/or methods of the invention. It is contemplated that any composition, component or method described herein can be implemented with respect to any other composition, component or method described herein.

The term “or” in the claims refers to “and/or” unless explicitly indicated to refer to alternatives only or the alternatives are mutually exclusive, although the disclosure supports a definition that refers to only alternatives and “and/or”.

The terms “comprise” and “comprising” are used in the inclusive, open sense, meaning that additional elements may be included.

The term “including” is used herein to mean “including, but not limited to”, “Including” and “including but not limited to” are used interchangeably.

The term “about” is used herein to refer to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

The terms “oil herding agent” and “oil herder” are interchangeable.

In one embodiment of the invention, there is provided an oil herding agent comprising a biocompatible non-ionic functionalized polysaccharide. Further to this embodiment, the oil herding agent may comprise a non-toxic vehicle. In this further embodiment, the non-toxic vehicle may be water.

In both embodiments the biocompatible non-ionic functionalized polysaccharide may be a konjac glucomannan. In both embodiments the konjac glucomannan comprises octadecyl isocyanate and 1,3-propane sultone. In an aspect of both embodiments the konjac glucomannan may be a radiation-induced degraded konjac glucomannan. In this aspect the radiation induced degraded konjac glucomannan may comprise short polymeric chains each independently with a molecular weight of about 300 KDa to about 1000 KDa. Also in this aspect the radiation induced degraded konjac glucomannan may have a hydrophilic head comprising a sulfonate functionalized pyranose ring and a hydrophobic tail comprising the octadecyl group.

In another embodiment of the present invention there is provided a method for containing spread of an oil spill on a water surface at a low water temperature, comprising applying the oil herding agent as described supra along a perimeter of the oil spill on the water surface. In this embodiment the low water temperature may be about −1.7° C. to about 4° C. Also in this embodiment the oil herding agent decreases oil surface area and increases oil thickness of the oil spill.

In yet another embodiment of the present invention there is provided a method for preparing an oil herder, comprising irradiating a biocompatible non-ionic polysaccharide with electron beam radiation to form a biocompatible non-ionic functionalized polysaccharide, thereby preparing the oil herding agent.

In this embodiment the biocompatible non-ionic polysaccharide may be a konjac glucomannan. Also in this embodiment the biocompatible non-ionic polysaccharide may be irradiated with a dose of about 1.21 kGy to about 300 kGy. Particularly the biocompatible non-ionic polysaccharide is irradiated with about 1.21 kGy, about 5 kGy, about 9 kGy, or about 16 kGy.

In yet another embodiment of the present invention there is provided a radiation-induced degraded konjac glucomannan oil herder comprising octadecyl isocyanate and 1,3-propane sultone produced by the method as described supra. Further to this embodiment the radiation-induced degraded konjac glucomannan oil herder may comprise a non-toxic vehicle. In this further embodiment, the non-toxic vehicle may be water.

In both embodiments the radiation-induced degraded konjac glucomannan oil herder may comprise a sulfonate functionalized pyranose ring and a hydrophobic tail comprising the octadecyl group. Also in both embodiments the radiation-induced degraded konjac glucomannan oil herder may comprise short polymeric chains each independently with a molecular weight of about 300 KDa to about 1000 KDa.

In yet another embodiment of the present invention there is provided a method for increasing a slick thickness ratio of an oil slick on a water surface, comprising applying the radiation-induced degraded konjac glucomannan oil herder as described supra along a perimeter of the oil slick on the water surface. In this embodiment the water surface may have a temperature of about −1.7° C. to about 4° C. Also in this embodiment increasing the slick thickness ratio of the oil slick decreases a surface area thereof.

Provided herein is an innovative oil herder or oil herding agent prepared from a natural plant-based product, konjac. The konjac glucomannan (KGM) is the base material used to develop the proposed oil herder, which is a natural polysaccharide and has flexibility in functionalization (Behera and Ray, 2016; Nishinari, 2000). The easily degraded functionalized konjac glucomannan materials have both hydrophobic tails to be attached and hydrophilic backbones forming the surfactant structure. The natural konjac glucomannan material could be functionalized to work as the efficient oil herder. Compared with traditional ionic surfactant, the non-ionic functionalized konjac glucomannan surfactant does not have Krafft temperature limits and its herding efficiency is not restricted at low temperatures around 0° C. It is demonstrated that functionalized konjac glucomannan has great potential to work as an efficient biocompatible oil herder for a wide range of temperatures, especially suitable for oil spills response in Arctic circle.

When inevitable accidents occur at sea, crude oil leaks out, spreading across the water surface and stabilizing as a very thin layer. After the herder (float on water and surround oil) was spread around the oil, the bulk oil slick started to shrink and become thicker. In the side view of oil herding theory initially had the tendency to spread out to become a very thin oil slick surface due to the gravitational force and smaller surface tension. Before herding surfactant was applied, oil on water surface system experienced three forces, the oil-water surface tension (γ_{O/W}), the oil-air surface tension (γ_{O/A}) and the air-water surface tension (γ_{A/W}). Water is a highly polar solvent and has high surface tension (γ_{A/W}=72.5 mN/m). The γ_{O/W} and γ_{O/A} majorly depend on oil and water properties and the net sum value (γ_{O/W}+γ_{O/A}) is around 25 mN/m. Higher γ_{A/W} made the oil slick quickly spread outside from center until γ_{A/W} and (γ_{O/W}+γ_{O/A}) value are the same. At this moment, the oil slick became a very thin layer and reached the equilibrium state. The herder structure in consists of a hydrophobic tail and hydrophilic head. After the herder was applied to the sea, the equilibrium state of γ_{A/W} and (γ_{O/W}+γ_{O/A}) was broken. The hydrophilic head dissolved on the water surface and to form a monolayer, and the hydrophobic tail forms an interface between the air and the water, which in effect greatly reduced the air-water surface tension (γ_{A/W}<25 mN/m). Higher γ_{O/W}+γ_{O/A} value motivated oil slick to contract until all surface tensions reach to the new equilibrium. At this moment, the oil slick became a much thicker bulk. The oil slick on water was always moving to the direction of the equilibrium state and surface tensions are also adjusting at the same time.

Konjac glucomannan is composed of 1,4-linked D-glucose and D-mannose residues as the main chain, with branches through β-1,6-glucosyl units. The degree of branching is estimated at approximately 3 for every 32 sugar units. It consists of mannose and glucose units in a molar ratio of 1.6:1 and the acetyl groups along the KGM backbone, which contribute to solubility properties are located every 9 to 19 sugar units at the C-6. Similar to PEG, konjac is a water-soluble polymer and has more hydroxyl (—OH) group to functionalize as surfactants. Konjac naturally contains of great amounts of natural polysaccharide. The Konjac glucomannan chemical structure is:

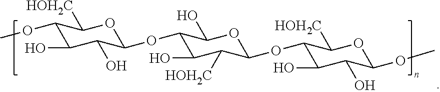

Konjac is grown mostly in Asian countries, including Japan, Korea, China, and southeast Asia countries. Konjac is broadly utilized in the food, nutraceutical, and cosmetics industries. The greatest value of konjac corn flour is its component konjac glucomannan (KGM). Konjac is the only economic crop that can provide Konjac glucomannan in large quantities. Natural polysaccharides have recently garnered interest in the polymeric surfactants area because of their facile production, environmental friendliness, and non-toxic characteristics.

Konjac glucomannan powder needs to perform the pretreatment before further surface functionalization. The undegraded Konjac glucomannan polymer has large molecular weight and very long hydrophilic backbone which will increase time to form monolayer on water-air surface and further increase the herding time. Polymer degradation needs to be taken to shorten the polymer chain length, which could be later testified through molecular weight measurement. Smaller molecular weight suggests shorter polymer backbone chain. The degraded polymer surfactant had shorter chains and required less time for backbone to stretch out to form monolayer for more efficient herding. Furthermore, the degraded surfactant has decreased polymer coil in tendency due to the efficient packing of hydrophobic tails and prevented unnecessary aggregates formation, reducing the invalid polymer aggregate surfactant.

High energy particle beam like γ-ray or e-beam was already broadly used for polysaccharides backbone chain scission. The long polymeric chain broken down using the e-beam irradiation. The degradation mechanism of Konjac glucomannan by the chain scission of the polymeric chain is carried out by irradiating the Konjac glucomannan samples with radiation doses of 1.21 kGy, 5 kGy, 9 kGy and 16 kGy. Gy (Gray) is an SI-derived unit of ionizing radiation and 1 kGy=1000 J/Kg. KGMs are capable of handling e-beam irradiations of the range 300 kGy. Konjac glucomannan samples can be irradiated with radiation doses up to 300 kGy.

The stability of the oil-water emulsion induced by adding the modified konjac glucomannan is anticipated due to the combination of steric and electrostatic repulsion between the surfactant engulfed oil droplets (Pradeep Venkataraman, 2013).

This emulsification property of modified konjac glucomannan can be exploited in the treatment of oil spills with dispersants. Dispersants are surfactants used on the spilled oil to aid the breaking of oil into small droplets due to the reduction in interfacial-tension. The conversion of oil layer formed on the water surface to small oil droplets enhances the bioremediation of the oil spills. As proven by Pradeep Venkataraman et. al the hydrophobically modified chitosan-a biopolymer, can be used to considerably enhance the stability of crude oil droplets which is dispersed by the chemical dispersant Corexit 9500A and help in reducing the use of Corexit 9500A.

The hydrophobization modification of konjac glucomannan has introduced surfactant property to it and the functionalization is characterized using FT-IR. The long polymeric chain of konjac glucomannan acts as the hydrophilic backbone which dissolves in water and the hydrophobic tail formed by grafting of octadecyl isocyanate prefers to stay away from the water molecules. Modified Konjac glucomannan displays excellent emulsification property and it may be used along with commercial dispersants like Corexit to stabilize the dispersed oil droplets and thus warrants reduced quantity of dispersants used during oil spill mitigation process.

The modified konjac glucomannan surfactant is bulky due to the long hydrophilic polymer chains which makes the formation of monolayer at the air-water interface a slow process. It was also observed that the aggregation tendency of the polymeric structure of modified konjac glucomannan reduces the packing efficiency of the hydrophobic tail along the air-water interface resulting is minor reduction of surface tension of water, making modified Konjac glucomannan ineffective crude oil herder. However, the modified konjac glucomannan surfactant demonstrates oil herding on lighter oils like dodecane. The slowness to form monolayer and poor packing at air-water interface of modified konjac glucomannan may be resolved if the polymeric chain length of konjac glucomannan can be reduced. The modified konjac glucomannan is showing dispersing abilities when demonstrated with crude oil.

The comparison on the solubility behavior of ionic surfactant sodium dodecyl sulfate with the non-ionic surfactants—modified konjac glucomannan and PEG-monooleate shows that the they both display opposite behavior when the temperature in varied. The ionic surfactants clearly show an increase in the solubility as temperature increase and is characterized by a sudden increase in conductivity when the temperature attains the Kraft temperature (Tₖ). However, for non-ionic surfactant modified konjac glucomannan the conductivity decreases with increase in temperature explaining the absence of Tₖ for modified konjac glucomannan surfactant. This absence of Tₖ gives modified konjac glucomannan surfactant unique ability to not lose its surfactant ability at low temperature nearing 0° C. and opens its way to act as efficient oil herders for low temperature waters, especially for oil spills in Arctic waters.

The hydrophobically modified konjac glucomannan surfactant demonstrates oil herding capabilities on lighter oils like dodecane. The e-beam irradiation of konjac glucomannan at doses of 16 kGy and further hydrophobic modification of the degraded konjac glucomannan resulted in surfactants with shorter hydrophilic polymer chain lengths. The lab scale oil herding experiments using dodecane oil illustrate that the decrease in polymeric chain increases the efficiency of the oil herding. This increase in oil herding efficiency may be due to faster monolayer formation at the air-water interface and more efficient packing of the macromolecules resulting in denser hydrophobic tails arrangement. The degradation of KGM did not show to have any negative impact on the herding ability in low temperature water (1° C.). Furthermore, e-beam irradiation is a safe method and it does not have any harming effect in the irradiated product.

The following examples are given for the purpose of illustrating various embodiments of the invention and are not meant to limit the present invention in any fashion. One skilled in the art will appreciate readily that the present invention is well adapted to carry out the objects and obtain the ends and advantages mentioned, as well as those objects, ends and advantages inherent herein. Changes therein and other uses which are encompassed within the spirit of the invention as defined by the scope of the claims will occur to those skilled in the art.

### Example 1

### Materials and Methods

### Chemicals

The following materials were used to functionalize the konjac glucomannan (KGM) surfactant: konjac glucomannan high viscosity powder which is used as the base material to synthesize the surfactant, octadecyl isocyanate, ethyl acetate, 1,3-propane sultone, potassium carbonate and N,N-dimethyl formamide. Konjac glucomannan is vacuum dried for 24 hours and sample sets of 5 g are packed in a polyethylene bags of dimension 2 cm×7.5 cm which is placed inside another polyethylene bag of dimension 7.5 cm×14 cm.

### Characterization

The morphologies of pristine and modified konjac particles were imaging at JSM-7500F JEOL field-emission scanning electron microscope (FE-SEM). The molecular weight measurement was performed at TOSOH ambient temperature gel permeation chromatography system (GPC). The chemical structure of konjac particles were tested through Fourier-transform infrared spectroscopy (FTIR). All photographs were taken through Supereyes B007 USB digital microscope portable camera and SONY Alpha a600 camera. The temperature tests in this work were measured with thermometer Omega hh11b. The conductivity was tested with CON 6 hand-held conductivity meter.

### ImageJ Software Analysis

ImageJ was the software for analyzing and calculating the oil slick areas in this work. It is an imaging processing program through Java based language and could transfer colorful photograph into black & white photograph for pixels analyzing. Through ImageJ, every oil herding picture was transferred into pixels. The crystallizing dish area was known and transferred to pixels. Then the oil slick occupied black pixels were measured and converted to oil slick areas by the crystallizing dish pixels. Thus, the different herding time oil slick areas were achieved.

### Example 2

### Electron Beam Irradiation Method

Laboratory reclosable polyethylene (PE) bags were prepared, and into each was packaged five grams of pristine konjac glucomannan powders. The dimension of the PE bag was 7.5 cm×14 cm. The konjac glucomannan samples are placed on the single conveyance systems that moves the sample through the process chamber where the electron beams are subjected on them. The sample packet is attached with a radiation absorbing probe that absorb the radiation along with the sample. These probes are used along with the calibrated readings to calculate the irradiation dose on the sample. The four samples are each irradiated to 1.21 kGy, 5 kGy, 9 kGy and 16 kGy. Gy (Gray) is an SI-derived unit of ionizing radiation. 1 Gy is equal to 1 J/Kg, representing the absorption of 1 joule of radiation per kilogram.

### Synthesis of the Surfactant

The synthesis of the herder was carried out in a two-step process. The synthetic scheme for the functionalized Konjac glucomannan is below.

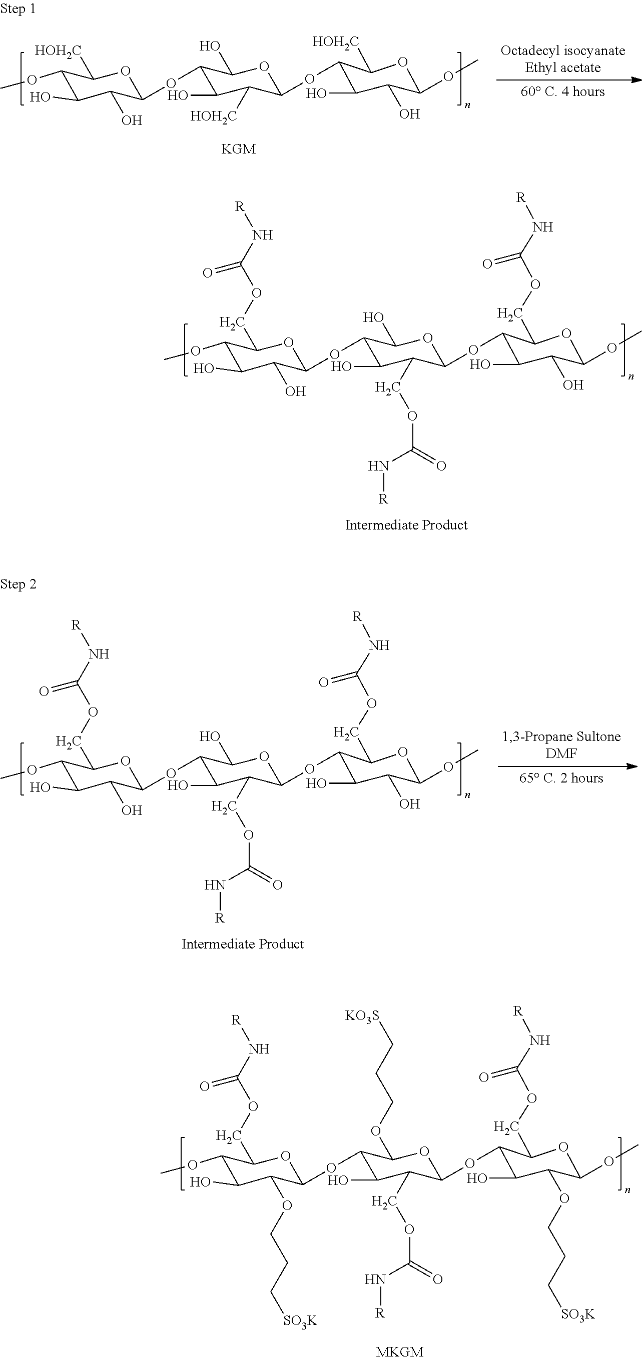

The first step was the hydrophobization of the konjac glucomannan. The sequential procedure for step is, the base material konjac powder is first dried in a vacuum drier for 24 hours to remove any residual moisture present in the powder. The vacuum dryer is used instead of a laboratory equipment dryer because the warm air circulating inside the dryer can alter the properties of the konjac glucomannan. konjac glucomannan (5 g) is taken in a 250 ml round bottom flask and ethyl acetate (100 ml), the solvent for the reaction is added to it.

The mixture is shaken manually for 1 minute and then sonicated in for 15 minutes in VWR Model 50T Ultrasonic cleaner to get a homogenous mixture. The hydrophobization of konjac glucomannan is carried out using octadecyl isocyanate, the hydrophobic tail that is grafted to the konjac glucomannan structure. Octadecyl isocyanate (1 g) is added to the round bottom flask and then sonication is repeated for 15 minutes. The chemical grafting takes place under continuous stirring for 4 hours at 60° C. The reaction mixture is centrifuged in Thermo Scientific CL 2 Centrifuge at 3900 rpm for 3 minutes to separate the solvent from the reacted mixture. The residue mixture is again washed in ethyl acetate and re-centrifuged at 3900 rpm for 5 minutes. The excess ethyl acetate is drained out and the residual mixture is dried overnight in the vacuum pump in preparation for step 2.

The step 2 comprises of attaching charges to the polymeric chain. The steps followed are, the residual sample (1 g) from step one is taken in a 250 ml round bottom flask. 1,3-propane sultone (0.5 ml), potassium carbonate (0.15 g) and the solvent N,N-dimethyl formamide (20 ml) is added to the sample and mixture is continuously stirred for 1.5 hours at 70° C. The reaction mixture is centrifuged at 3900 rpm for 4 minutes to separate the solvent from the reacted mixture. The residue mixture is again washed in acetone and re-centrifuged at 3900 rpm for 3 minutes. The acetone is drained out and the residual mixture is dried in the vacuum pump overnight to form the modified konjac glucomannan.

### Characterization of Pure Konjac Glucomannan and the Modified Konjac Glucomannan (MKGM)

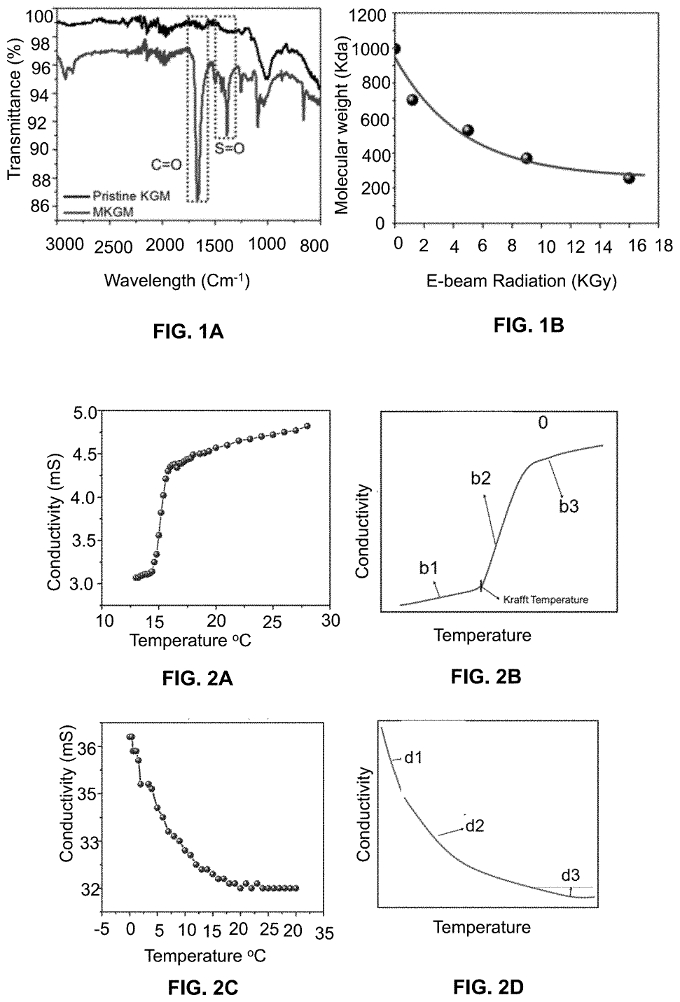

Fourier transform infrared spectroscopy (FTIR) and gel permeation chromatography (GPC) were investigated for proving surface functionalization of modified konjac glucomannan and the e-beam radiation effect (shown in FIGS. 1A-1B). Pristine konjac glucomannan and modified konjac glucomannan was carried out through FTIR. From FIG. 1A, the peaks for modified konjac glucomannan at 1390 cm-1 and at 1650 cm-1 represented S═O and C═O groups, while konjac glucomannan didn't show peak in the same wavelength. This variance indicated the chemical reaction of synthesis, ODI successfully grafted to konjac glucomannan in step 1 and 1,3-Propane Sultone in step 2 in the synthetic scheme. FIG. 1B represented GPC molecular weight result related to e-beam radiation. It was clear that the molecular weight of konjac glucomannan gradually decreased after exposure to e-beam radiation. The molecular weight decreased to 290,000 g/mol at 16 kGy radiation compared with initial 1,000,000 g/mol. As discussed above, the lower-molecular-weight modified konjac glucomannan exhibited better herding surfactant efficiency. Further investigation was undertaken to examine the internal physical structure of pristine konjac glucomannan and modified konjac glucomannan through scanning electron microscope (SEM). konjac glucomannan and modified konjac glucomannan exhibited an irregular shape and no clear difference between them was observed, proving that the e-beam radiation and surface functionalization did not break the macrostructure of konjac powder.

### Conductivity Measurement of Sodium Dodecyl Sulfate

The hand-held conductivity/TDS meter CN 6/TDS 6 of Oakton instruments was used to measure the conductivity and the temperature of the sample.

Sodium dodecyl sulfate (Ionic surfactant): sodium dodecyl sulfate in deionized water solution (0.1 mol/l) was prepared in a 200 ml glass beaker. The solution was stored in refrigerator at 5° C. for 24 hours. The sodium dodecyl sulfate surfactant has crystallized below the 5° C. atmosphere. The glass beaker was taken out of the refrigerator and placed on a hot plate stirrer. The conductivity meter probe was immersed into the solution. The dual measuring mode of conductivity meter could measure both the conductivity and the temperature. The solution was slightly heated to remain 0.2° C./min increase. The measured conductivity and temperature data were drawn in FIGS. 2A-2B.

Modified konjac glucomannan (Non-ionic surfactant): 0.25 wt % of modified konjac glucomannan (16 kGy) in 200 ml water solution was kept overnight under refrigeration to maintain the temperature at 0° C. The conductivity meter probe immersed into the solution measured both the conductivity and temperature. The solution was slightly heated to achieve 0.2° C./min increment. The conductivity versus temperature plot is shown in FIGS. 2C-2D.

### Example 3

### Oil Herding Process Experiment

The lab-scale oil herding process experiment was first tested. The crystallizing dish simulated the sea environment. Artificial sea water was prepared using ASTM International standard protocol (ASTM D1141-98) with deionized (DI) water and dissolved mineral salts. The oil spill was replaced with dodecane (C₁₂H₂₆) due to its liquid alkane hydrocarbon characteristic. The water was dyed with water-soluble methylene blue; the oil dodecane was dyed with oil-soluble Sudan IV for easier observation. A portable camera was clamped to a supporting mast and positioned above the crystallizing dish to record changes of the oil slick.

A Pyrex® 190 X 100 dish was prepared. The diameter and height of the dish is 190 mm and 100 mm respectively. Then 0.4 ml red pigmented dodecane is carefully applied on the water surface using a transfer pipette and waited till the oil has spread out and stabilized. Once the oil layer is stable, 0.4 ml herder (MKGM/water ratio 0.0025 (wt/vol) is applied around the edges of the oil layer using a transfer pipette. The oil starts to retract slowly. The images of the herding process are taken at regular interval and when the retracted oil attains stability. The approximate time when the oil retraction becomes stable is noted as the total herding time, which was observed to be 45 minutes.

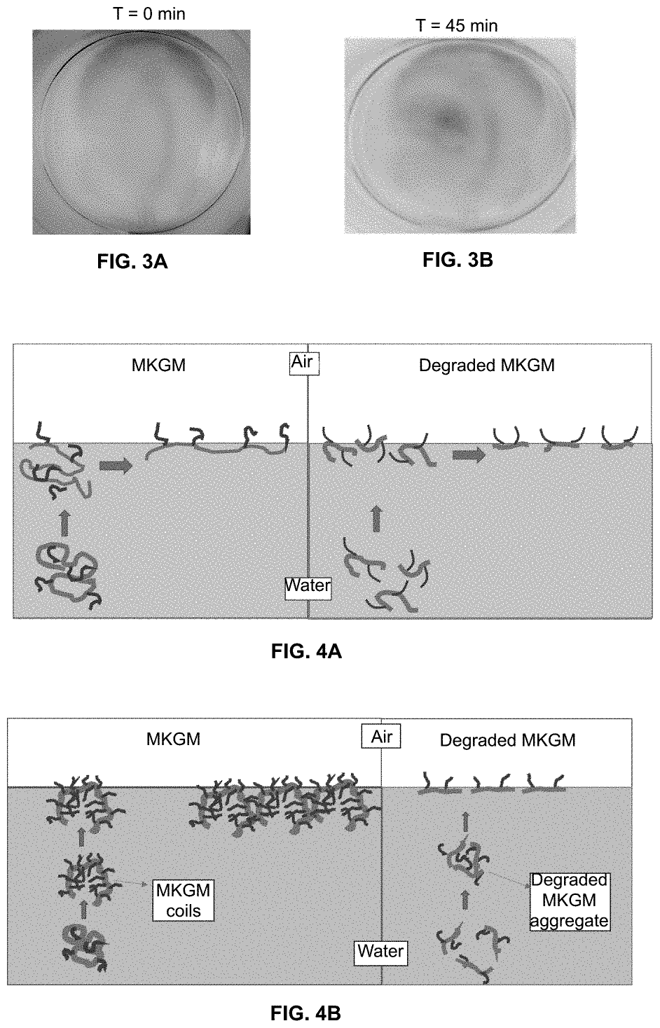

Using the image processing program ImageJ, the surface area of the oil layer and the retracted oil is calculated as shown in FIGS. 3A-3B. Based on the volume of the oil added the thickness of the herded oil is calculated. The area of the oil retracted from 101.5 cm² to 19.65 cm², that is an area reduction of 80.61% in area and the oil thickness increased from 0.039 mm to 0.2 mm, that is an increase of 413% in thickness.

The Modified Konjac Glucomannan Surfactant Behavior after Diffusion in Water

The bulky and long hydrophobic chain increase the time take to form the monolayer on the water surface. This lag time for the modified konjac glucomannan surfactant to adsorb to the air-water interface to form a monolayer may be attributed to many factors. The macromolecules of modified konjac glucomannan that is in the solution needs to diffuse to the surface so that the hydrophobic tail reduces its interaction with the water molecules and stay in contact with the air. After reaching the surface the surfactant macromolecules will tend to stretch-out and form a straight chain along the surface with the hydrophobic tail attaching itself to the non-polar phase. The nature of the hydrophobic tail and its affinity to non-polar phase can determine the time taken for the tails to anchor to the non-polar phase. The stiffness of the hydrophilic backbone also determines the rate at which the stretch-out takes place. (Desbrièresb, 2004) (Widad Henni, 2004). The slowness of the herding may also be attributed to the inability of the modified konjac glucomannan surfactant to reduce the air-water surface tension to the desired level. This may be due to geometry and physical packing of the hydrophobic tails along the interface. The schematic arrangement of hydrophobic tails along the water surface in dense packing and in less dense packing. The surface tension reduction is higher when the hydrophobic tails arranges densely as it forms a near perfect layer between the water and the air, reducing the interaction of molecules of both the phases. The hydrophobic chains may also show attraction towards each other that would account for the formation of dense aggregates of hydrophobic tails causing the polymer backbone to coil inwards and reduce the number of hydrophobic tails settling on the air-water interface as shown. The modified konjac glucomannan surfactant structures bulk dilution will result in interfacial polymer arrangement. This tendency of modified konjac glucomannan surfactants to coil inwards will increase its stabilization time at the air-water interface. (Widad Henni, 2004).

Clearly, it is observed that the degraded modified konjac glucomannan surfactant herds the same quantity of dodecane in the same experiment setup in 30 minutes, whereas, the non-degraded modified konjac glucomannan surfactant herded dodecane in 45 minutes. This result shows that hydrophobic modification of degraded konjac glucomannan results in a more effective oil herder. The shorter hydrophilic polymer chain backbone may be causing a faster movement of the diffused modified konjac glucomannan macromolecules to the water surface. The hydrophobic tails are now attached to smaller polymeric backbone, it takes lesser time for the hydrophobic tails to anchor to the non-polar phase as shown in the FIG. 4A. Additionally, the shorter polymeric backbone has a lesser tendency to coil-in due to the attraction of hydrophobic tails and thus prevent formation of aggregates that cause a smaller number of hydrophobic tails to be arranged on the non-polar phase as shown in FIG. 4B.

Oil Herding Experiment with Degraded Modified Konjac Glucomannan Solution in Toluene as Delivering Agent

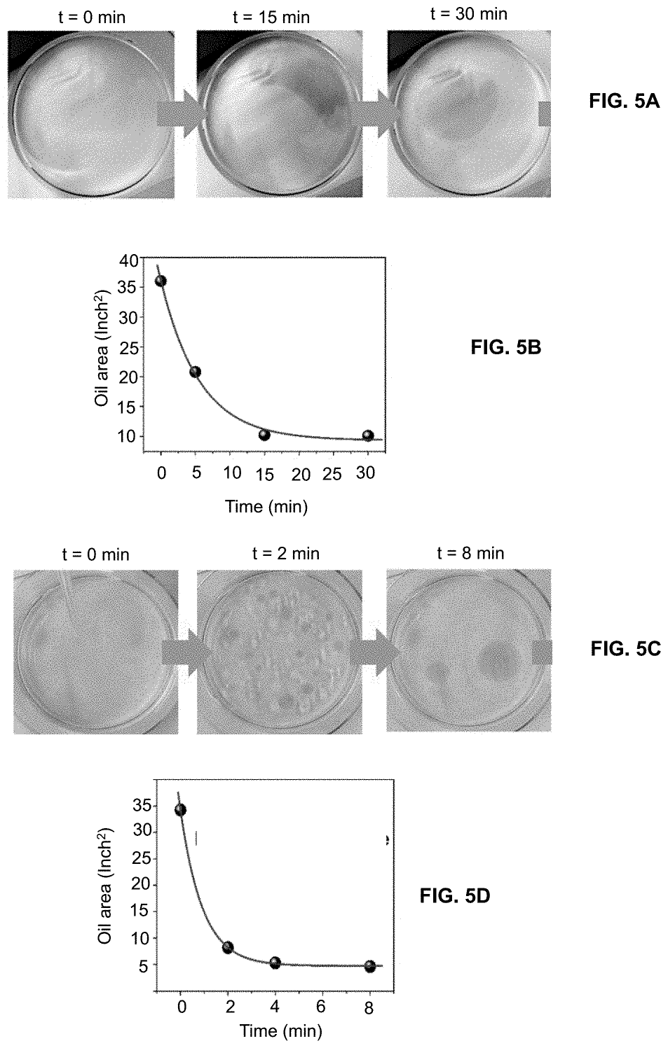

The modified konjac glucomannan (MKGM) synthesis route was as shown in the synthetic schematic. The efficacy of modified konjac glucomannan herder in different solvent delivery agents (water and toluene), were investigated. The modified konjac glucomannan tested in this case had been subjected to a 9 kGy radiation dosage. FIGS. 5A-5D showed oil herding through modified konjac glucomannan at 25° C. in water (FIG. 5A and FIG. 5B) and toluene (FIG. 5C and FIG. 5D) in the crystallization dish. Software ImageJ was used to analyze the images of the oil slick area in different times.

In FIG. 5A, water was used for the solvent delivery agent. 0.4 ml dodecane (dyed red), simulating an oil spill, was applied to the water surface. Once the oil layer stabilized, 0.25 wt % herder in water (0.2 ml) was spread to the edge of oil layer through a pipette. After 30 minutes of oil herding process, the oil area reached equilibrium and herding process was complete (FIG. 5B). The herding process was effective but slow. The solvent polarity was assumed to be a factor in the efficiency of the herding process.

It has been reported that toluene could be used as the solvent delivery agent. In FIGS. 5C and 5D, the nonpolar solvent toluene replaced water in the crystallization dish. Similarly, 0.4 ml dodecane (dyed red) simulating an oil spill was applied on the surface and allowed to reach equilibrium, then 0.25 wt % herder in toluene (0.2 ml) was spread to the edge of oil layer to start the herding process. Time to equilibrium and the herding time decreased to 8 minutes. Water needed to take 2.75 times longer than toluene and toluene proved to be the better delivery agent. The herding improvement might result from the better distribution of the modified konjac glucomannan. Considering the lower density of toluene and its nonpolar characteristics, the modified konjac glucomannan macromolecules dispersed with toluene would form a thin layer in the air-water interface instead of diffusing into water. This behavior would reduce the time for the macromolecules to align the air-water interface and thus reduce the oil herding process.

Oil Herding Experiment with Degraded Modified Konjac Glucomannan in Low Temperature Water

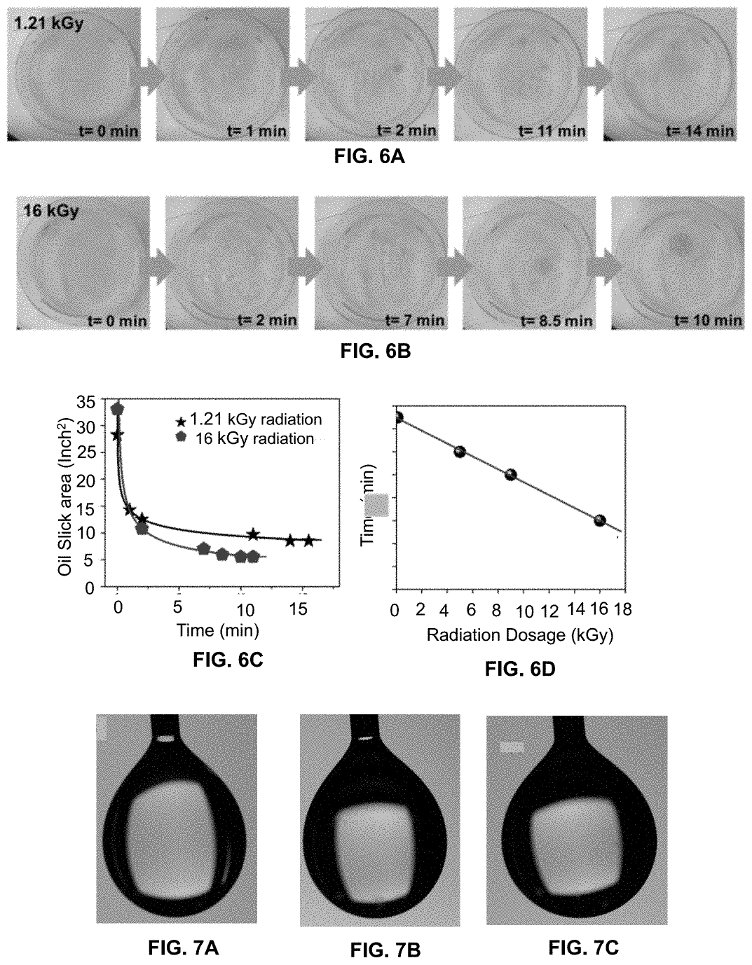

The e-beam radiation dosage of modified konjac glucomannan then was evaluated to affect herding efficiency in low temperature areas. Sea water was cooled to and maintained at 1° C. and the circulating bath flow was set to the bottom of crystallizing dish for maintaining the low temperature environment. FIG. 6A and FIG. 6B demonstrate the herding process with modified konjac glucomannan receiving e-beam radiation dosages of 1.21 kGy and 16 kGy. Software ImageJ was used to evaluate the oil slick areas in different times. The oil slick data was as recorded in FIG. 6C. The oil slick area first decreased and finally stabilized. The herding process was complete at 14 minutes (1.21 kGy) and 10 minutes (kGy). Then all different e-beam radiation dosage of modified konjac glucomannan herding were performed and the herding time was measured as shown in FIG. 6D. The herding times of 14.5 min, 12 min, 10 min, and 6 min, showed a linear relation with radiation dosage. The results further demonstrated that the lower-molecular-weight modified konjac glucomannan (achieved from various dosing e-beam radiation) exhibited better herding surfactant efficiency.

### Measurement of Surface Tension Using Pendant Drop Tensiometry

Pendant drop tensiometry is a simple method to measure the surface and interfacial tension of a surfactant solution. The process of fitting Young-Laplace equation that balances the gravitational force acting on the liquid droplet against the interfacial tension which gives a typical axisymmetric fluid droplet forms the basis of technique followed. This method can measure the surface tension just by capturing the shape of the liquid droplet suspended from the pendant drop needle using a camera connected to a computer.

The surface tension of pure DI water, hydrophobically modified konjac glucomannan in water solution in ratio 0.05 (wt/vol), Degraded and hydrophobically konjac glucomannan (16 kGy) in water solution in ratio 0.05 (wt/vol) was measured using the pendant drop method to compare the results.

The solution is first collected in the dispensing syringe and slowly the fluid is released to form a droplet. The fluid is released such that the maximum droplet size is achieved before it breaks to get the most accurate measurement. The droplet image is captured in the camera connected to the computer. A lamp is placed at the opposite side of the camera to give a shadowed image of the droplet in the camera, so that the image of outline of the droplet is captured perfectly. The software OpenDrop Master is used to calculate the surface tension, the captured image being the input to the software as shown in FIGS. 7A-7C.

The surface tension for pure DI water, pure konjac glucomannan solution and Degraded and hydrophobically modified konjac glucomannan are 79.06 mN/m, 77.50 mN/m and 77.18 mN/m. It is concluded from the surface tension measurement that the hydrophobically modified konjac glucomannan does not have extreme influence on interfacial tension. The e-beam irradiation of KGM at doses of 1.21 kGy, 5 kGy, 9 kGy and 16 kGy and further hydrophobic modification of the degraded konjac glucomannan resulted in surfactants with different hydrophilic polymer chain lengths. The lab scale oil herding experiments using dodecane oil and the four different samples of surfactants illustrate that the decrease in polymeric chain increases the efficiency of the oil herding. This increase in oil herding efficiency may be due to faster monolayer formation at the air-water interface and more efficient packing of the macromolecules resulting in denser hydrophobic tails arrangement.

The degradation of konjac glucomannan did not show to have any negative impact on the herding ability in low temperature water (1° C.). Thus, e-beam degradation of natural polysaccharides may be an exciting area to be explored to functionalize biocompatible surfactants for oil spill recovery mechanisms. Furthermore, e-beam irradiation is a safe method and it does not have any harming effect in the irradiated product. The maximum irradiation dose that could be achieved was 16 kGy for this research setup. However, irradiation doses in the range of 50 kGy to 100 kGy will cause more degradation and it may be interesting to understand the improvement in oil herding when konjac glucomannan is subjected to higher doses.

Using toluene as the solvent for releasing the surfactants the time taken to herd the oil improves when compared to discharging surfactant using water as solvent. This may be due to the faster and efficient distribution of surfactant macromolecules on the air-water interface. The measurement of surface tension of pure DI water, modified konjac glucomannan solution and degraded modified konjac glucomannan solution shows that the interfacial influence of konjac glucomannan based surfactants is not high enough to use them as oil herders in an efficient manner.

### Determination of Krafft Point by Measurement of Conductivity

Krafft temperature and solubility behavior of the ionic surfactant SDS and the non-ionic surfactant modified konjac glucomannan were discussed in FIGS. 2A-2D. FIG. 2A and FIG. 2C showed the data of sodium dodecyl sulfate and modified konjac glucomannan conductivity versus temperature, and FIG. 2B and FIG. 2D drew the plot of ionic and non-ionic surfactant molecular arrangement. The conductivity measurement was proven to be able to identify the Krafft temperature. Krafft temperature is the minimum temperature for surfactant to form micelles. There is an abrupt large solubility increase above the Krafft temperature. Surfactant working temperature should be higher than Krafft temperature for surfactant functioning.

First, 200 ml of SDS in deionized water solution of 0.1 mol/L concentration was prepared in a 200 ml glass beaker. The solution was left in refrigerator at 5° C. for 24 hours. This process has brought about the crystallization of the surfactant. The glass beaker is taken out of the refrigerator and placed on a hot plate stirrer (CORNING PC-420). The probe stick of the conductivity meter (TDS meter CON 6/TDS 6) is inserted into the solution. The dual measuring mode of conductivity meter can measure both the conductivity and the temperature. The conductivity of the solution is recorded from 12° C. and measured till 28° C. The solution is slightly heated to attain a steady temperature rise. The conductivity is measured at regular intervals of temperature (0.2° C. raise) and noted down. The whole process took about 2.5 hours. The results of the experiment are recorded in Table 1. The conductivity (mS) v/s Temperature (° C.) is plotted as shown in FIG. 4A.

TABLE 1
The Conductivity measurement at different
temperatures for SDS (0.1 mol/L) in water

| Sn. | Temperature (° C.) | Conductivity | |
|---|---|---|---|
| 1 | 13 | 3.07 | mS |
| 2 | 13.2 | 3.07 | mS |
| 3 | 13.4 | 3.09 | mS |
| 4 | 13.6 | 3.1 | mS |
| 5 | 13.8 | 3.11 | mS |
| 6 | 14 | 3.11 | mS |
| 7 | 14.2 | 3.12 | mS |
| 8 | 14.4 | 3.14 | mS |
| 9 | 14.6 | 3.25 | mS |
| 10 | 14.8 | 3.34 | mS |
| 11 | 15 | 3.56 | mS |
| 12 | 15.2 | 3.82 | mS |
| 13 | 15.4 | 4.02 | mS |
| 14 | 15.6 | 4.21 | mS |
| 15 | 15.8 | 4.3 | mS |
| 16 | 16 | 4.35 | mS |
| 17 | 16.2 | 4.37 | mS |
| 18 | 16.4 | 4.38 | mS |
| 19 | 16.6 | 4.34 | mS |
| 20 | 16.8 | 4.39 | mS |
| 21 | 17 | 4.39 | mS |
| 22 | 17.2 | 4.41 | mS |
| 23 | 17.4 | 4.43 | mS |
| 24 | 17.6 | 4.44 | mS |
| 25 | 17.8 | 4.45 | mS |
| 26 | 18 | 4.49 | mS |
| 27 | 18.6 | 4.5 | mS |
| 28 | 19 | 4.51 | mS |
| 29 | 19.4 | 4.53 | mS |
| 30 | 20 | 4.57 | mS |
| 31 | 21 | 4.6 | mS |
| 32 | 22 | 4.65 | mS |
| 33 | 23 | 4.67 | mS |
| 34 | 24 | 4.7 | mS |
| 35 | 25 | 4.72 | mS |
| 36 | 26 | 4.75 | mS |
| 37 | 27 | 4.77 | mS |
| 38 | 28 | 4.82 | mS |

In FIG. 2A, there was a clear increase in conductivity with temperature. There were 3 parts for the data set. Within the first part (13° C. to 14.4° C.), the conductivity increase in conductivity was slow. In the second part starting from 14.6° C., there was a sudden large increase in conductivity, which demonstrating that the Krafft temperature and the monomer solubility achieved to critical micelle concentration (CMC). Starting from the second part, the micelles formed while monomers began to decrystallize. In the third part, the conductivity increment speed slowed down and micelles were still forming. Correspondingly, schematic illustration of ionic surfactant molecular alignment with the temperature was explained in FIG. 2B. FIG. 2B at point b1 showed the crystallized monomers of the ionic surfactants below the Krafft temperature. Monomers crystallized and have no herding surfactant shape and effect. FIG. 2B at point b2 represented the formation of micelles when the Krafft temperature was crossed and the micelles increase conductivity of the solution. In FIG. 2B at point b3, there was continuing formation of micelles. The ionic surfactant crystallized and had no herding surfactant functionality below Krafft temperature. The ionic surfactant was only working while the atmosphere temperature was above Krafft temperature. This restriction also largely limited the surfactant usage rate.

### Conductivity Measurement of Degraded Modified Konjac Glucomannan

First, 0.25% (w/w) of 200 ml of Degraded Modified konjac glucomannan (DMKGM) (irradiated to 16 kGy) with water solution is put in refrigerator for 24 hours to bring the temperature to 0° C. The measurement of conductivity is carried out as mentioned above. The conductivity is measured at regular intervals of temperature and noted down. The whole process took about 3 hours. The results of the experiment are recorded in Table 2. The conductivity (μS) v/s temperature (° C.) is plotted as shown in FIG. 2C. It is clear from the FIG. 2C that there is a steady decrease in the conductivity of the solution when temperature is increased. Unlike sodium dodecyl sulfate, degraded modified konjac glucomannan does not show any abrupt increase in conductivity and does not appear to have a Krafft temperature. This phenomenon can be explained with the behavior of non-ionic solutions with temperature. The decrease in the conductivity can be traced to the decrease in solubility of degraded modified konjac glucomannan in water as temperature increase as shown in FIG. 2D.

TABLE 2
The Conductivity measurement at different temperatures
for DMKGM (0.25% (w/w)) in water

| Sn. | Temperature (° C.) | Conductivity | |
|---|---|---|---|
| 1 | 0 | 35.2 | mS |
| 2 | 0.4 | 35.2 | mS |
| 3 | 0.6 | 34.9 | mS |
| 4 | 0.8 | 34.9 | mS |
| 5 | 1 | 34.9 | mS |
| 6 | 1.2 | 34.9 | mS |
| 7 | 1.6 | 34.7 | mS |
| 8 | 2 | 34.2 | mS |
| 9 | 3.4 | 34.2 | mS |
| 10 | 4 | 34.1 | mS |
| 11 | 5 | 33.7 | mS |
| 12 | 6 | 33.5 | mS |
| 13 | 7 | 33.2 | mS |
| 14 | 8 | 33.1 | mS |
| 15 | 9 | 33 | mS |
| 16 | 10 | 32.8 | mS |
| 17 | 11 | 32.7 | mS |
| 18 | 12 | 32.5 | mS |
| 19 | 13 | 32.4 | mS |
| 20 | 14 | 32.4 | mS |
| 21 | 15 | 32.3 | mS |
| 22 | 16 | 32.2 | mS |
| 23 | 17 | 32.2 | mS |
| 24 | 18 | 32.1 | mS |
| 25 | 19 | 32.1 | mS |
| 26 | 20 | 32 | mS |
| 27 | 21 | 32.2 | mS |
| 28 | 22 | 32 | mS |
| 29 | 23 | 32.1 | mS |
| 30 | 24 | 32 | mS |
| 31 | 25 | 32 | mS |
| 32 | 26 | 32 | mS |
| 33 | 27 | 32 | mS |
| 34 | 28 | 32 | mS |
| 35 | 29 | 32 | mS |
| 36 | 30 | 32 | mS |
| 37 | 31 | 32.2 | mS |
| 38 | 32 | 32.3 | mS |
| 39 | 33 | 32.4 | mS |
| 40 | 34 | 32.3 | mS |
| 41 | 35 | 32.4 | mS |
| 42 | 36 | 32.4 | mS |
| 43 | 37 | 32.4 | mS |
| 44 | 38 | 32.4 | mS |
| 45 | 39 | 32.4 | mS |
| 46 | 40 | 32.4 | mS |
| 47 | 41 | 32.4 | mS |

Different than ionic surfactants, non-ionic surfactant modified konjac glucomannan exhibited distinct conductivity tendencies versus temperature. In FIG. 2C, there was a steady decrease in the conductivity of the solution with temperature increment. Unlike sodium dodecyl sulfate, konjac glucomannan did not show any abrupt increase in conductivity and did not appear to have a Krafft temperature. The molecular alignment of non-ionic was performed in FIG. 2D. The hydrophilic polymer chain was stretching in low temperature and will started to coil-in in high temperature to some extent. (FIG. 2D). The molecular alignment did not affect the surfactant functioning well. The absence of Krafft temperature for non-ionic surfactant is a great advantage in low temperature (0° C.) oil spill treatment environment, while ionic surfactant would crystallize to solid and lost herding efficiency in that temperature range.

### Biocompatibility of Modified Konjac Glucomannan Herder

A simple biocompatibility test was performed for the modified konjac glucomannan herder. Edible black beans, red beans, and pinto beans were purchased from local supermarket. 12 black beans, 12 red beans, and 9 pinto beans were randomly chosen and set aside in lab atmosphere for 7 days. All beans did not sprout and kept their original shape. Beans were separated into three plastic petri dishes, into which four black beans, four red beans and three pinto beans each were placed. Three water environments were simulated, and beans were immersed with reference sea water, 0.25 wt % pristine KGM in sea water, and 0.25 wt % modified konjac glucomannan in sea water for 7 days. All beans sprouted in a normal speed. The konjac glucomannan and Surface modification of konjac glucomannan in sea water did not affect the growth of the beans, which also proved the biocompatibility of the herder.

### Example 4

### Herding Efficiency of Polyethylene Glycol as Surfactant

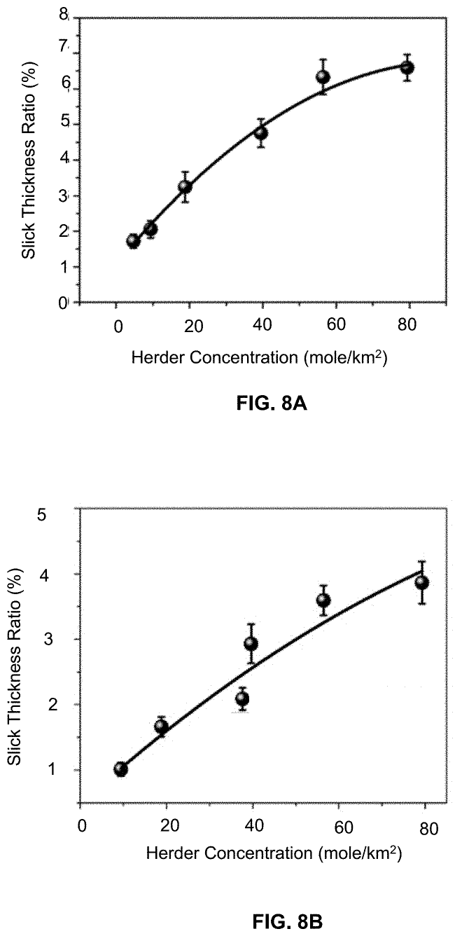

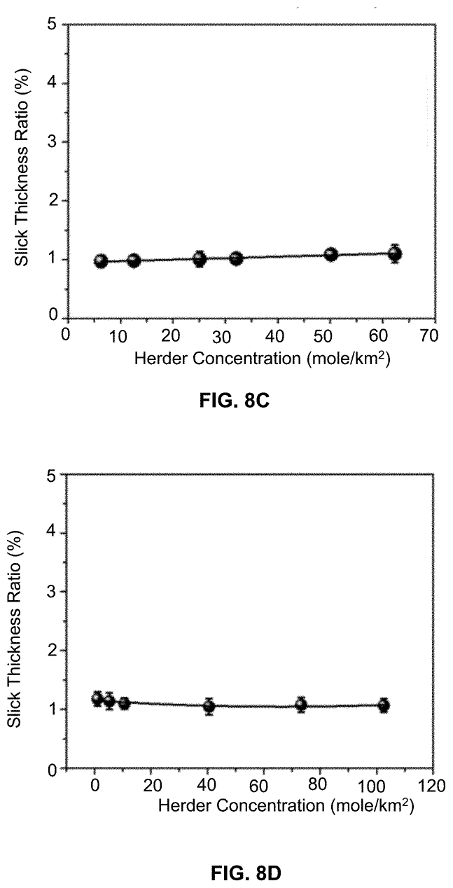

Herding surfactant is essentially a surface-active agent. To preliminarily investigate the material herding efficiency to oil, suitable polymer surfactants with hydrophobic head and hydrophilic tail were tested. Polyethylene glycol (PEG) is a water soluble polymer and easy to couple with hydrophobic chain to form surfactant. Four common lab PEG derivatives were chosen as herders for testing, as shown in FIGS. 8A-8D. The experiments were performed at room temperature. The slick thickness ratio is defined as below:

$$Slick thickness ratio ( \% ) = \frac{S table Oil thickness before herding}{Stable Oil thickness after herding} \qquad ( Eq . 1 )$$

Higher slick thickness ratio implied better herding quality. From FIG. 8A and FIG. 8B, the slick thickness ratio largely increased with herder concentration increment while the oil slick, accordingly, shrunk. The same changes could be also seen from the two insets, which demonstrated that PEG-monolaurate and PEG-monooleate surfactants were efficient in herding. While for FIG. 8C and FIG. 8D, the slick thickness ratio remained mostly the same when herder concentration increased, demonstrating that PEG-dibenzoate and PEG-disterate were not suitable for herding oil. The effectiveness of surfactants at herding oil is directly related to the chemical structure of the PEG derivatives. FIG. 8A and FIG. 8B showed good herding ability due to their amphiphilic characteristics. The reason of slick thickness ratio curve of FIG. 8C and FIG. 8D remained flat were assumed to be its internal chemical structure large benzene rings and two side longer carbon chains. The benzene rings and longer carbon chains affected the steric hindrance of materials and largely restricted the hydrophobic side reaction with oil slick. They could not perform herding effect and thus curves in FIG. 8C and FIG. 8D remained flat, and the thickness ratio was close to 1.

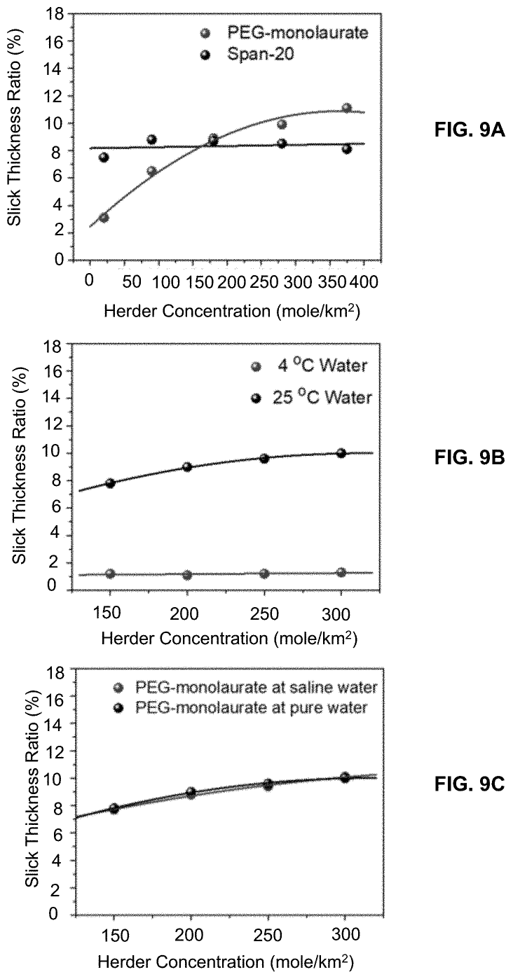

More comparisons were tested to study herder efficiency with different commercial surfactants at varying temperatures and salinity. In FIG. 9A, both surfactants, Span-20 and PEG-monolaurate, presented good herding ability with large slick thickness ratios at 25° C. In FIG. 9B, the PEG-monolaurate retained high herding ability under 25° C. While temperature decreased to 4° C., which is close to Arctic Ocean temperature, oil slickness ratio maintained around 1.0, regardless of the herder concentration increment. The results demonstrated that PEG-monolaurate was not a good herder for oil spill response in low-temperature areas. Then herding efficiency of PEG-monolaurate surfactant in saline water and pure DI water was tested. As shown in FIG. 9C, there was no clear oil slick thickness ratio change between PEG-monolaurate in pure water and 3.5% saline water, meaning the surfactant was not significantly affected by salinity. The results suggested to design and synthesize one new herding surfactant to replace PEG-monolaurate for overcoming the low temperature herding defect.

### Emulsification Property of Modified Konjac Glucomannan

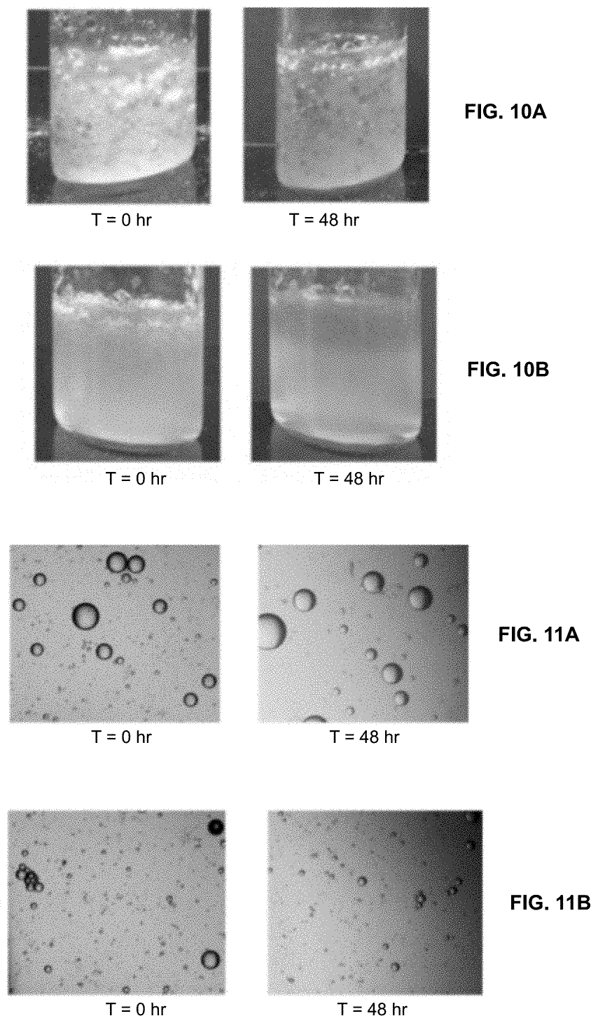

The hydrophobic modification of konjac glucomannan gives it a surfactant like structure and alters its interfacial properties. To observe the changes in the interfacial properties of the modified konjac glucomannan (MKGM), 4 ml modified konjac glucomannan solution in water in ratio 0.0025 (wt/vol) was mixed with 4 ml of red pigmented dodecane in a vial. The red pigmentation to the dodecane was provided by adding Sudan IV powder. Similarly, 4 ml of pure konjac glucomannan solution in water in ratio 0.0025 (wt/vol) was mixed with 4 ml of red pigmented dodecane in a vial. Both the mixtures in the vial were shaken manually for 30 seconds and was left undisturbed for 48 hours. FIGS. 10A-10B are photographs of both the vials taken at the start of the experiment and after 48 hours.

Konjac glucomannan is a long chain polymer (polysaccharide) known for their ability to form gels when dissolved in water. Presence of large number of hydroxyl (—OH) groups helps it bind the water molecules resulting in a viscous mixture. The gel like property is attributed to the cross-linked network formed within the water. (Dipjyoti Saha, 2010) (M. Davidovich-Pinhas, 2014). FIG. 10A shows the gel like mixture of dodecane in water due to the cross-links provided by konjac glucomannan and shows high stability of the gel-like mixture when observed after 48 hours. FIG. 10B shows the oil-water emulsion formed with the help of modified konjac glucomannan and the stability of the emulsion after 48 hours.

The optical microscopic image of the pure konjac glucomannan in oil-water mixture shown in FIG. 11A clearly show the oil droplets trapped in between the water bound by the cross-links of the pure konjac glucomannan. FIG. 11B show the optical microscopic image of the oil-water emulsion at the start and at 48th hour. The relatively smaller oil droplets when compared between FIGS. 11A and 11B is the indication of the surfactant nature of modified konjac glucomannan. The relatively similar size of the oil droplets at t=0 hour and at t=48 hour shown in FIG. 11B is due to the resistance to coalescence of oil droplets resulting in a highly stable oil-water emulsion. The modified konjac glucomannan engulfs the oil droplet and forms a layer around it with the hydrophobic tail anchoring to the oil droplet and the hydrophilic head outwards in contact with the water.

### Konjac Glucomannan as Dispersant

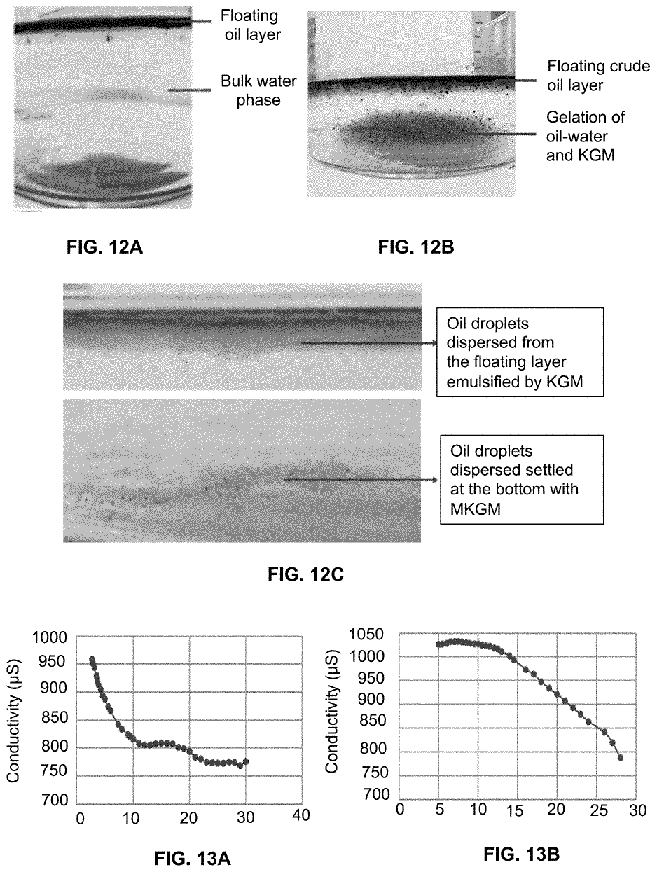

2 ml of Texas Crude is applied on the water surface which is at 22° C. The top view and side view of the crude oil is shown in FIG. 12A. 0.5 g of pure KGM powder is dispersed on the oil layer and the observations are shown in FIG. 12B showing the gelation of the konjac glucomannan and the crude droplets. The modified konjac glucomannan powder is dispersed on the oil layer, the dispersion of oil droplets was observed as shown in FIG. 12C. This experiment demonstrate that the modified konjac glucomannan can be used as dispersants. The effectiveness of dispersion can be further explored by carrying out different functionalizations.

### Example 5

### Conductivity Measurement of Polyethylene Glycol Monooleate (PEG Monooleate)

PEG Monooleate is also a non-ionic surfactant and the conductivity v/s temperature of this surfactant in water at 0.1 mol/L concentration was conducted. In this experiment the sample was first cooled to 2.7° C. and then the increase in conductivity was noted up to 30° C. The same sample was cooled by applying ice around the 250 ml glass beaker and the conductivity was recorded till the temperature dropped to 5° C. The conductivity v/s temperature graphs are shown in FIGS. 13A-13B. The results clearly show that for non-ionic surfactants the solubility decreases with increase in temperature and it is a reversible process, that is, the solubility increases with decrease in temperature.

Thus, the comparison on the solubility behavior of ionic surfactant-SDS with the non-ionic surfactants—modified konjac glucomannan and PEG monooleate shows that the they both displays opposite behavior when the temperature in varied. The ionic surfactants clearly show an increase in the solubility as temperature increase and is characterized by a sudden increase in conductivity when the temperature attains the Kraft Temperature (Tₖ). However, for non-ionic surfactant modified konjac glucomannan the conductivity decreases with increase in temperature explaining the absence of Tₖ for modified konjac glucomannan surfactant. This absence of Tₖ gives modified konjac glucomannan surfactant unique ability to not lose its surfactant ability at low temperature nearing 0° C. and opens its way to act as efficient oil herders for low temperature waters, especially for oil spills in Arctic waters.

The following references are cited herein.
Agency, U. E. 1993. Understanding Oil Spills and Oil Spill Response. Publication Number 9200.5-105.
Aggarwal et al. 2017. Cold Regions Science and Technology, 135, 97-104.
Agrawal et al. 2008, Environmental Science & Technology, 42(19), 7098-7103.
Babak, V, & Desbrières, J., 2004. Mendeleev Communications, 14(2), 66-69.
Baffes, J., 2007. Resources Policy, 32(3), 126-134.
Bakshi, et al., 2005. Journal of colloid and interface science, 287(1), 288-297.
Barron, M. G. 2012. Toxicologic Pathology.
Behera, S. S., & Ray, R. C., 2016. International journal of biological macromolecules, 92, 942-956.
Bentley, R. W. 2002. Energy policy, 30(3), 189-205.
Binks, B. 2002. Current Opinion in Colloid & Interface Science, 7(1-2), 21-41.
Blumer, et al. 1971. Environment: Science and Policy for Sustainable Development, 13(2), 2-12.
Brown, et al. 1987. Management Science, 33(3), 335-346.
Buckmaster, J. 1973. Journal of Fluid Mechanics, 59(3), 481-491.
Buist, I., & Meyer, P. 2012. Paper presented at the Proceedings of the Thirty-fifth AMOP Technical Seminar on Environmental Contamination and Response.
Dave, et al., 2011. American Journal of Environmental Sciences, 7(5), 423.
Dave, et al. 1998. Polymer, 39(5), 1139-1148.
Dipjyoti Saha, S. B. 2010. Food Science Technology.
Ermakov, et al. 198). Dynamics of atmospheres and oceans, 10(1), 31-50.
Evdokimov et al. 2005. Jour of colloid and interface science, 285(2), 795-803.
Fanbing Meng a, L. Z. 2013. Food Hydrocolloids.
Fay, J. 1969. Oil on the Sea.
Fei, et al. 2018. Advanced Materials, 30(35), 1802146.
Fingas, M. 2010. Oil Spill Science and Technology. Elsevier.
Goldberg, V. P., 1994. The Journal of Legal Studies, 23(1), 1-39.
Gryczka, et al. 2009. Radiation Physics and Chemistry, 78(7-8), 543-548.
Gundlach, et al., 1978. Marine technology society Journal, 12(4), 18-27.
Gupta, D, 2015. Science advances, 1(5), e1400265.
Henni, et al. 2005. Journal of colloid and interface science, 281(2), 316-324.
Huang et al. 2019. Jour of Loss Prevention in Process Industries, 103948.
Iakovou et al. 1997. European Journal of Operational Research, 96(1), 72-80.
Imai, T., et al. 1994. Applied Entomology and Zoology, 29(3), 389-393.
Inácio, et al. 2013. Antimicrobial agents and chemotherapy, 57(6), 2631-2639. International Energy Agency. (2018). Market Report Series: Oil 2018.
Itopf. 2017. Oil tanker spill statistics 2016. In: ITOPF London, UK.
Jesus, C. D. (2016). Retrieved from futurism.com/thousands-of-small-oil-spills-are-destroying-the-gulf-of-mexico
Kalita, et al. 2016. Materials Science and Engineering: C, 60, 84-91.
Katsuraya, et al. 2003. Constitution of konjac glucomannan: chemical analysis and 13C NMR spectroscopy. Carbohydrate polymers, 53(2), 183-189.
Kaushik, M. 2019. 11 Major Oil Spills Of The Maritime World. Retrieved from https://www.marineinsight.com/environment/11-major-oil-spills-of-the-maritime-world/
Komoto, et al. 2004. The Journal of organic chemistry, 69(3), 680-688.
Luo et al. Journal of Polymer Research, 19(4). doi:10.1007/s10965-012-9849-x
Muhd Julkapli, et al. 2011. Composite Interfaces, 18(6), 449-507.
Nishinari, K. 2000. In G. Doxastakis & V. Kiosseoglou (Eds.), Developments in Food Science, Vol. 41, pp. 309-330, Elsevier.
Paine, R. T. et al. 1996. Annual Review of Ecology and Systematics, 27(1), 197-235. Patrizio Raffa, (2015). Chemical reviews.
Peterson, et al. Science, 302(5653), 2082-2086. Retrieved from science.sciencemag.org/content/302/5653/2082.long
Rico, et al., 1986. The Journal of Physical Chemistry, 90(22), 5870-5872.
Silliman et al. Proc of the National Academy of Sci, 109(28), 11234-11239.
Takigami, S. 2009. 32—Konjac mannan. In G. O. Phillips & P. A. Williams (Eds.), Handbook of Hydrocolloids (Second Edition) (pp. 889-901): Woodhead Publishing.
Tester, et al. 2016. Journal of the Science of Food and Agriculture, 96(10), 3283-3291.
Tian, et al. 2010. Journal of colloid and interface science, 343(1), 344-349.
Urquhart, R. D., 1986. Journal of Canadian Petroleum Technology, 25(02), 5. doi:10.2118/86-02-05
Vargaftik, N. 1983. Jour of Phys and Chem Reference Data, 12(3), 817-820.
Venkataraman et al. 2013. ACS applied materials & interfaces, 5(9), 3572-3580.
Winger, et al. 2009. Molecular Physics, 107(13), 1313-1321.
Woo, et al. 2002. Radiation Physics and Chemistry, 63(3-6), 845-850.
Wu, et al. 2015. Carbon, 93, 473-483.
Xu, et al. 2007. Carbohydrate polymers, 70(4), 444-450.
Zhang et al. 2001. Biopolymers: Original Res on Biomolecules, 59(1), 38-50.
Zhang, et al. 2005. Carbohydrate polymers, 60(1), 27-31.

What is claimed is:

1. An oil herding agent comprising a biocompatible non-ionic functionalized polysaccharide.

2. The oil herding agent of claim 1, further comprising a non-toxic vehicle.

3. The oil herding agent of claim 2, wherein the non-toxic vehicle is water.

4. The oil herding agent of claim 1, wherein the biocompatible non-ionic functionalized polysaccharide is a konjac glucomannan.

5. The oil herding agent of claim 4, wherein the konjac glucomannan comprises octadecyl isocyanate and 1,3-propane sultone.

6. The oil herding agent of claim 4, wherein the konjac glucomannan is a radiation-induced degraded konjac glucomannan.

7. The oil herding agent of claim 6, wherein the radiation induced degraded konjac glucomannan comprises short polymeric chains each independently with a molecular weight of about 300 KDa to about 1000 KDa.

8. The oil herding agent of claim 6, wherein the radiation induced degraded konjac glucomannan has a hydrophilic head comprising a sulfonate functionalized pyranose ring and a hydrophobic tail comprising the octadecyl group.

9. A method for containing spread of an oil spill on a water surface at a low water temperature, comprising:
applying the oil herding agent of claim 1 along a perimeter of the oil spill on the water surface.

10. The method of claim 9, wherein the low water temperature is about −1.7° C. to about 4° C.

11. The method of claim 9, wherein the oil herding agent decreases oil surface area and increases thickness of the oil spill.

12. A method for preparing an oil herder, comprising:
irradiating a biocompatible non-ionic polysaccharide with electron beam radiation to form a biocompatible non-ionic functionalized polysaccharide, thereby preparing the oil herding agent.

13. The method of claim 12, wherein the biocompatible non-ionic polysaccharide is a konjac glucomannan.

14. The method of claim 12, wherein the biocompatible non-ionic polysaccharide is irradiated with a dose of about 1.21 kGy to about 300 kGy.

15. The method of claim 12, wherein the biocompatible non-ionic polysaccharide is irradiated with about 1.21 kGy, about 5 kGy, about 9 kGy, or about 16 kGy.

16. A radiation-induced degraded konjac glucomannan oil herder comprising octadecyl isocyanate and 1,3-propane sultone produced by the method of claim 12.

18. The radiation-induced degraded konjac glucomannan oil herder of claim 16 further comprising a non-toxic vehicle.

19. The radiation-induced degraded konjac glucomannan oil herder of claim 18, wherein the non-toxic vehicle is water.

20. The radiation-induced degraded konjac glucomannan oil herder of claim 16 comprising a sulfonate functionalized pyranose ring and a hydrophobic tail comprising the octadecyl group.

21. The radiation-induced degraded konjac glucomannan oil herder of claim 16 comprising short polymeric chains each independently with a molecular weight of about 300 KDa to about 1000 KDa.

22. A method for increasing a slick thickness ratio of an oil slick on a water surface, comprising:
applying the radiation-induced degraded konjac glucomannan oil herder of claim 16 along a perimeter of the oil slick on the water surface.

23. The method of claim 22, wherein the water surface has a temperature of about −1.7° C. to about 4° C.

24. The method of claim 22, wherein increasing the slick thickness ratio of the oil slick decreases a surface area thereof.
